(19) United States
(12) Patent Application Publication
(10) Pub. No.: US 2010/0158087 A1
(43) Pub. Date: Jun. 24, 2010

(54) Method and System for Detecting a First Symbol Sequence in a Data Signal, Method and System for Generating a Sub-Sequence of a Transmission Symbol Sequence, and Computer Program Products

(76) Inventor: Po Shin Francois Chin, Singapore (SG)

Correspondence Address: CROCKETT & CROCKETT, P.C., 26020 ACERO, SUITE 200, MISSION VIEJO, CA, 92691, US

(21) Appl. No.: 12/307,417

(22) PCT Filed: Jul. 2, 2007
(86) PCT No.: PCT/SG07/00195

§ 371 Date: Nov. 4, 2009

Related U.S. Application Data
(60) Provisional application No. 60/806,482, filed on Jul. 3, 2006.
(60) Provisional application No. 60/807,254, filed on Jul. 13, 2006.

(51) Int. Cl. H04B 17/00; H04L 27/00

(52) U.S. Cl. 375/224; 375/295

(57) ABSTRACT

A method for detecting a first symbol sequence in a data signal is described comprising receiving the data signal in which the first symbol sequence should be detected, wherein the first symbol sequence is expressable as the kronecker product of a second symbol sequence and a third symbol sequence; correlating the first symbol sequence with the third symbol sequence to generate a first correlation result; generating a second correlation result by correlating a fourth symbol sequence derived from the first correlation result with a fifth symbol sequence derived from the second symbol sequence by a transformation that maps all negative symbols of the second symbol sequence to non-negative symbols; and generating a detection result based on the second correlation result.

### FIELD OF THE INVENTION

Embodiments of the invention generally relate to a method and system for detecting a first symbol sequence in a data signal, a method and system for generating a sub-sequence of a transmission symbol sequence, and computer program products.

### BACKGROUND OF THE INVENTION

In radio communications, e.g. in UWB (Ultra Wide Band) radio communications, transmission packets typically include a preamble portion, for example used for the synchronization of the transmitter and the receiver, a synchronization frame delimiter marking the end of the preamble portion and a payload portion including the data to be transmitted.

Efficient methods and systems for generating and detecting a synchronization frame delimiter in a transmission packet are desirable.

### SUMMARY OF THE INVENTION

According to one embodiment of the invention, a method for detecting a first symbol sequence in a data signal is provided including receiving the data signal in which the first symbol sequence should be detected, wherein the first symbol sequence is expressable as the kronecker product of a second symbol sequence and a third symbol sequence; correlating the first symbol sequence with the third symbol sequence to generate a first correlation result;
generating a second correlation result by correlating a fourth symbol sequence derived from the first correlation result with a fifth symbol sequence derived from the second symbol sequence by a transformation that maps all negative symbols of the second symbol sequence to non-negative symbols; and
generating a detection result based on the second correlation result.

Further, a system and a computer program product according to the method for detecting a first symbol sequence in a data signal are provided according to embodiments of the invention.

According to another embodiment of the invention a method for generating a sub-sequence of a transmission symbol sequence is provided including selecting a first symbol sequence from a plurality of preamble symbol sequences, the preamble symbol sequences pre-stored to be used in a preamble portion of the transmission symbol sequence; generating a second symbol sequence based on the first symbol sequence; and
combining the second symbol sequence with a third symbol sequence selected from the plurality of preamble symbol sequences to generate the sub-sequence.

Further, a system and a computer program product according to the method for generating a sub-sequence of a transmission symbol sequence are provided according to embodiments of the invention.

### SHORT DESCRIPTION OF THE FIGURES

Illustrative embodiments of the invention are explained below with reference to the drawings.

FIG. 1 shows a communication arrangement according to an embodiment of the invention.

FIG. 2 shows a transmission frame according to an embodiment of the invention.

FIG. 3 shows a first table with examples for a ternary sequence according to an embodiment of the invention.

FIG. 4 shows a second table with examples for a ternary sequence according to an embodiment of the invention.

FIG. 5 shows a preamble followed by a synchronization frame delimiter according to an embodiment of the invention.

FIG. 6 shows a preamble and a long synchronization frame delimiter.

FIG. 7 shows a preamble and a long synchronization frame delimiter.

FIG. 8 shows a preamble and a long synchronization frame delimiter.

FIG. 9 illustrates the processing of a received signal.

FIG. 10 illustrates the processing of a received signal.

FIG. 11 illustrates the processing of a received signal according to an embodiment of the invention.

### DETAILED DESCRIPTION

Illustratively, in one embodiment, a method for detecting a first symbol sequence in a data signal is provided in which all negative symbols of a first correlation result, generated by correlating the first symbol sequence (e.g. a synchronization frame delimiter) with the third symbol sequence, are mapped to non-negative symbols. This means that in one embodiment (e.g. when all non-zero symbols are mapped to the same positive symbol) the sign information of the symbol sequence is removed.

In one embodiment, where sign information corresponds to phase information, when the sign information is removed the second symbol sequence, e.g. by converting it from a ternary sequence to a bipolar sequence, the need to track the phase of the first correlation result is eliminated. Further, lower correlation side lobes and thus better performance can be achieved.

In the method for detecting a first symbol sequence in a data signal according to an embodiment of the invention the detection result is for example the information whether the first symbol sequence is present in the data signal. The detection result is for example the position of the first symbol sequence in the data signal.

In one embodiment, the fourth symbol sequence is derived from the first correlation result by taking the absolute value of the first correlation result, i.e. taking the absolute values of the symbols of the first correlation result.
Illustratively, the sign information is removed from the first correlation result.

The first symbol sequence, the second code sequence and the third symbol sequence are for example three-valued sequences.

In one embodiment, the transformation maps all non-zero symbols of the second symbol sequence to positive symbols (e.g. the same positive symbol) and maps the zero symbols of the second symbol sequence to negative symbols (e.g. the same negative symbol).

The second symbol sequence is for example a ternary sequence and the fifth symbol sequence is for example the second symbol sequence transformed into a bipolar sequence. For example, the second symbol sequence is transformed into a bipolar sequence by replacing each component having the value 0 with −1 and replacing each component having the value 1 or −1 with 1. Components already having the value 1 do not have to be actively replaced but can be left unchanged.

In one embodiment, the data signal further includes a preamble symbol sequence including the third symbol sequence one or more times.

For example, the data signal further includes a data payload symbol sequence and the first symbol sequence marks the end of the preamble symbol sequence and the beginning of the data payload symbol sequence. The first symbol sequence is for example a synchronization frame delimiter.

In the method for generating a sub-sequence of a transmission symbol sequence according to another embodiment of the invention, illustratively, a sub-sequence of a transmission symbol sequence, for example to be used as a synchronization frame delimiter in the transmission symbol sequence, is generated using a preamble symbol sequence which can be used in the preamble of the transmission symbol sequence. For example, a list of preamble symbol sequences is stored in a transmitter that may be used by the transmitter for the preamble of a transmission symbol sequence, i.e. a transmission frame. The sub-sequence is generated based on the preamble sequence. As a result, for example, the sub-sequence has the same underlying sequence pattern as the preamble symbol sequence and may be generated with low implementation complexity.

In the method for generating a sub-sequence of a transmission symbol sequence according to an embodiment of the invention, the sub-sequence is for example generated as the kronecker product of the second symbol sequence and the third symbol sequence.

In one embodiment, the second symbol sequence is generated based on a fourth symbol sequence which is the first symbol sequence, the first symbol sequence with the sign of each symbol being inverted, a cyclically shifted version of the first symbol sequence or a cyclically shifted version of the first symbol sequence with the sign of each symbol being inverted.

A high randomness of the sub-sequence can be achieved in this way improving the detection probability of the sub-sequence in the transmission symbol sequence while keeping the implementation complexity low.

Further, the second symbol sequence may be generated based on the fourth symbol sequence and a fifth symbol sequence which is a sixth symbol sequence selected from the plurality of preamble symbol sequences, the sixth symbol sequence with the sign of each symbol being inverted, a cyclically shifted version of the sixth symbol sequence or a cyclically shifted version of the sixth symbol sequence with the sign of each symbol being inverted.

The transmission symbol sequence for example includes a data payload symbol sequence and the sub-sequence for example marks the end of the preamble portion and the beginning of the data payload symbol sequence. For example, the sub-sequence is a synchronization frame delimiter.

In one embodiment, the sub-sequence is a biploar sequence or a ternary sequence.

The first symbol sequence, the second symbol sequence, and the third symbol sequence are for example two-valued sequences or three-valued sequences.

A two-valued symbol sequence is a sequence the components of which are from a set of two elements (for example real numbers). For example, bipolar sequences and unipolar sequences are two-valued sequences.

A bipolar sequence is a sequence the components of which are all from a set of one negative value and one positive value, e.g. {−1, 1}. For example, −1, 1, −1, −1, 1 is a bipolar sequence.

A unipolar sequence (or binary sequence) is a sequence the components of which are all from a set of 0 and a positive value, e.g. {0, 1}. For example, 0, 1, 0, 0, 1 is a unipolar sequence.

A three-valued sequence is a sequence the components of which are from a set of three elements (for example complex or real numbers). example, a ternary sequence is a three-valued sequence.

A ternary sequence is a sequence the components of which are all from a set of one negative value and one positive value and 0, e.g. {−1, 0, 1}. For example, 0, 1, −1, −1, 0 is a ternary sequence.

In the embodiments described below, the symbol sequences are also referred to as code sequences. A component of a code sequence, i.e. a symbol, is also called a chip.

A circuit can be a hardware circuit designed for the respective functionality or also a programmable unit, such as a processor, programmed for the respective functionality.

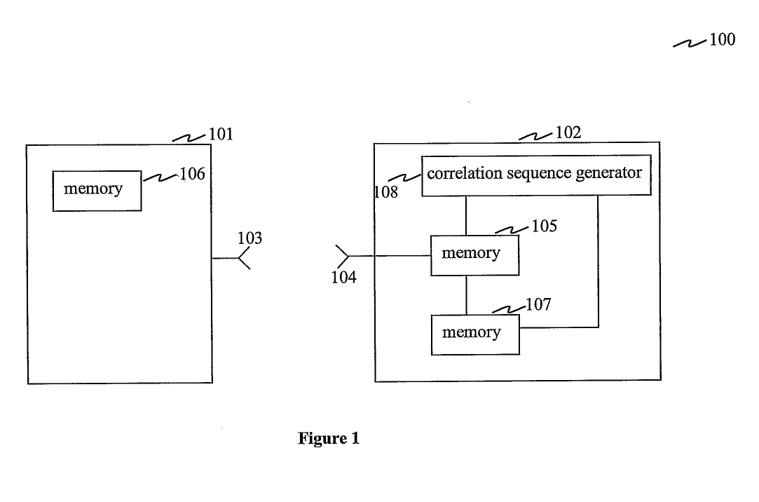

FIG. 1 shows a communication arrangement 100 according to an embodiment of the invention.

The communication arrangement includes a transmitter 101 and a receiver 102. The transmitter 101 and the receiver 102 for example communicate using UWB (ultra wide band) radio communication technology according to IEEE 802.15.4a standard or according to another UWB Wireless Personal Area Network systems, such as WiMEDIA Generation 2 systems.

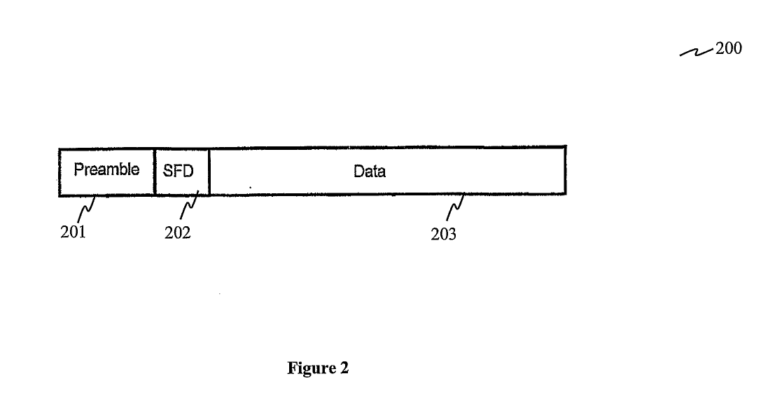

Data is transmitted by the transmitter 101 using a transmit antenna 103 via a communication channel to the receiver using a receiver antenna 104 in form of data packets. The form of the transmission of a data packet from the transmitter 101 to the receiver 102 is illustrated in FIG. 2.

FIG. 2 shows a transmission frame 200 according to an embodiment of the invention.

The transmission frame 200 includes a preamble 201, a synchronization frame delimiter (SFD) 202 and a payload data packet 203.

The synchronization frame delimiter 202 indicates the end of the preamble 201 and the packet arrival time, i.e. the start of the payload data packet 203. The synchronization frame delimiter 202 is detected by a detector 105 which determines the beginning of the payload data packet 203.

The preamble 201 for example includes the repetition of a code sequence T which is chosen such that it can be received effectively for the purposes of packet acquisition and time of arrival estimation by different receiver types for example by a coherent receiver and by an energy detector.

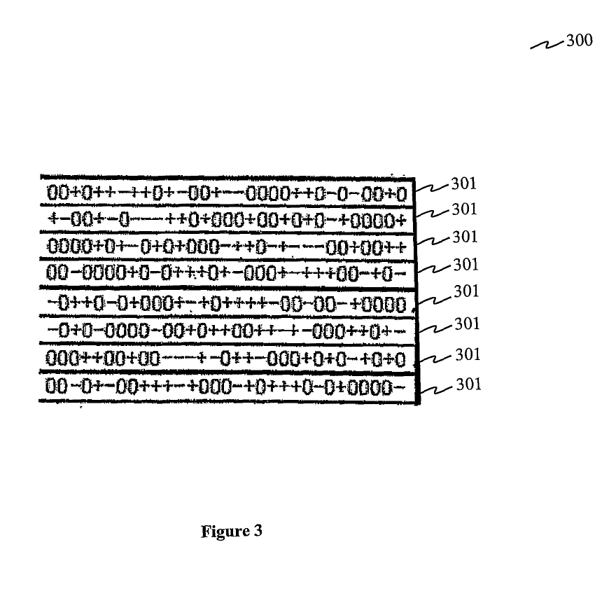

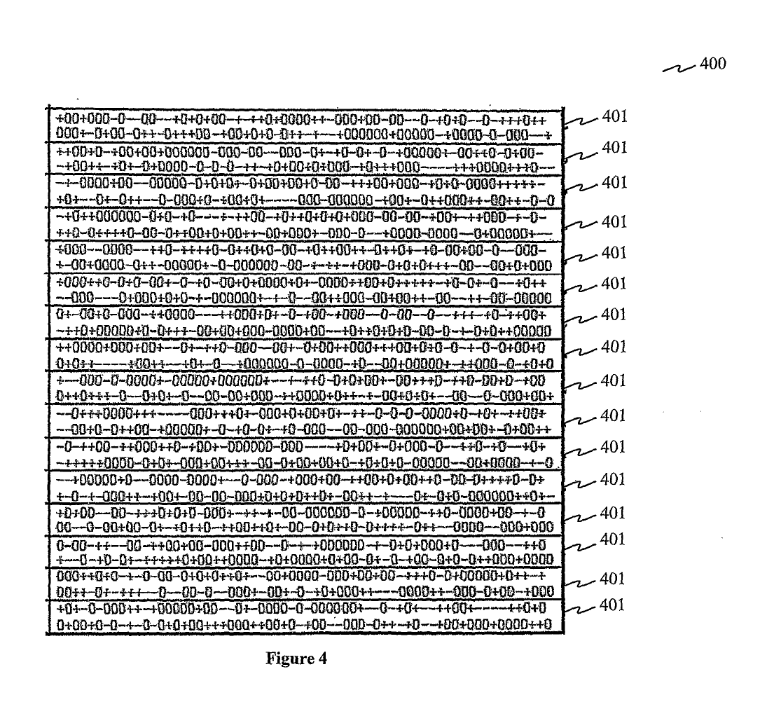

For example, the preamble includes the repetition of a N-chip ternary sequence T. T may also be a binary sequence or a bipolar sequence. Examples for the ternary sequence T are shown in FIGS. 3 and 4.

FIG. 3 shows a first table 300 with examples for a ternary sequence according to an embodiment of the invention.

Each row 301 of the first table 300 shows an example for the ternary sequence which may be used in the preamble 201. In this case, the ternary sequence is a 31-chip sequence. Eight examples are given.

FIG. 4 shows a second table 400 with examples for a ternary sequence according to an embodiment of the invention.

Each row 401 of the second table 400 shows an example for the ternary sequence which may be used in the preamble 201. In this examples, the ternary sequence is a 127-chip ternary sequence.

In each row, two parts of the respective ternary sequence are shown wherein the upper part is followed by the lower part in the respective sequence.

In FIGS. 3 and 4 and in the following, “+” indicates a +1 and “−” indicates a −1.
One or more symbol sequences that may be used as the sequence T are for example stored in a first memory 106 of the transmitter 101 and in a second memory 107 of the receiver 102.

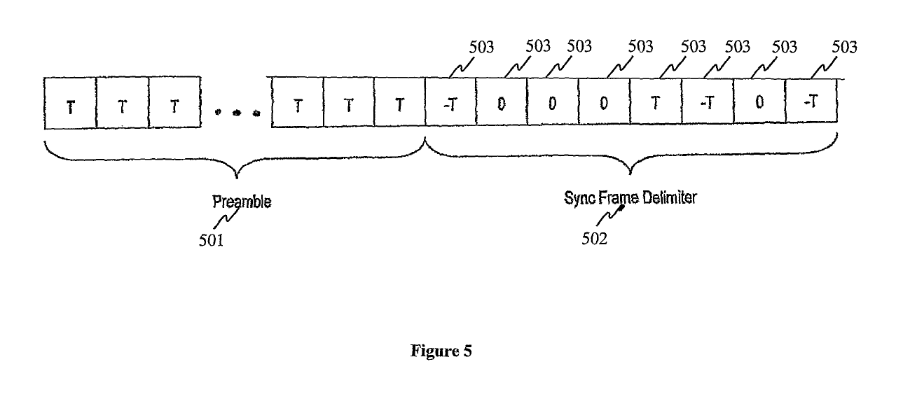

The synchronization frame delimiter 202 includes sequence blocks which are related to the ternary sequence T used for the preamble, such that a low complexity of the receiver 102 may be achieved. An example for a preamble 201 and a synchronization frame delimiter 202 is shown in FIG. 5.

FIG. 5 shows a preamble 501 followed by a synchronization frame delimiter 502 according to an embodiment of the invention.

The preamble 501 includes the repetition of the sequence T, which is in this example a N-chip ternary sequence. The synchronization frame delimiter 502 is a product of a P-chip ternary base sequence S and the ternary sequence T, i.e. SFD=S [symbol] T where [symbol] denotes the kronecker product or direct product. This means that [s₁, s₂, . . . , s_{P}] [symbol] T=[s₁*T, s₂*T, . . . , s_{P}*T] wherein sᵢ*T means the sequence T with all components being multiplied by sᵢ (for all i between 1 and P). Hence the kronecker product of a sequence S and a sequence T herein means the kronecker product (or also called direct product) for matrices with S being interpreted as a 1×P matrix and T being interpreted as a 1×N matrix.

In the example shown in FIG. 2, S=[−1,0,0,0,+1,−1,0,−1]. P is 8 in this example, such that the synchronization frame delimiter 502 includes 8 sequence blocks 503 wherein each sequence block is T, −T or a sequence of N zero chips (indicated by a 0).

The preamble 501 and the synchronization frame delimiter 502 are for example used according to the current IEEE 802.15.4a standard for low-rate low-power UWB Wireless Personal Area Network.

In the above example, the synchronization frame delimiter, including 8 times N chips, is a short synchronization frame delimiter. In transmission scenarios where the signal to noise ratio (SNR) is low, e.g. when the transmission range is long, there may be a need to lengthen the synchronization frame delimiter for better detection of the synchronization frame delimiter by the detector 105.

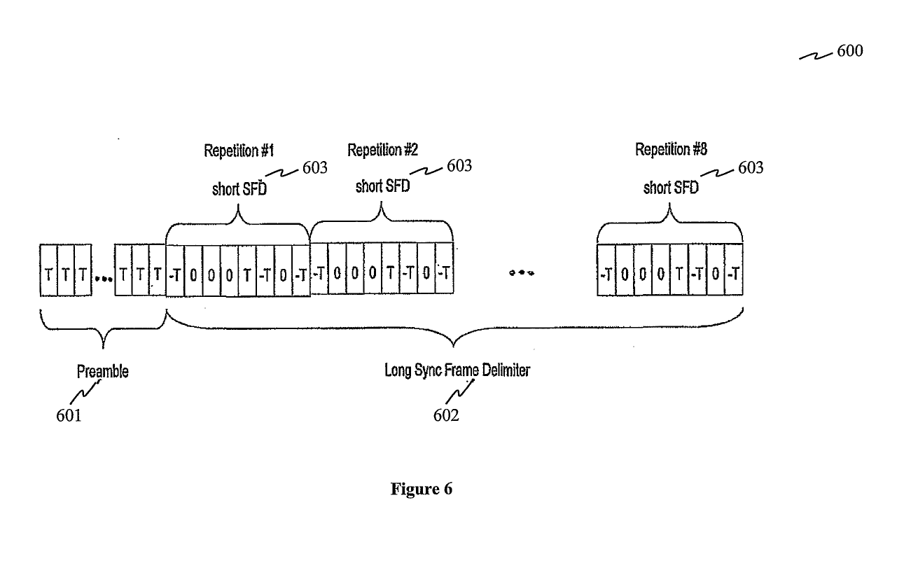

A simple method to generate a long synchronization frame delimiter from a short synchronization frame delimiter is to repeat a short synchronization frame delimiter. This is illustrated in FIG. 6.

FIG. 6 shows a preamble 601 and a long synchronization frame delimiter 602.

Similar to FIG. 5, the preamble 601 includes the repetition of the sequence T, which is in this example a N-chip ternary sequence.

The long synchronization frame delimiter 602 includes R=8 repetitions of a short synchronization frame delimiter 603 which corresponds to the synchronization frame delimiter 502 shown in FIG. 5 and accordingly includes P=8×8×N chips. Such a long synchronization frame delimiter 602 is for example adopted in the IEEE 802.15.4a standard specification draft for low-rate low-power UWB Wireless Personal Area Network. The disadvantage of such a highly structured long synchronization frame delimiter is a poor detection performance due to the gentle up-slope and down-slope of correlation peaks.

In one embodiment, to achieve good detection probability when SNR is low a long synchronization frame delimiter is used, which is in the following also denoted as code sequence W, of length P*N chips generated from a P-chip ternary sequence S=[s₁, s₂, . . . , s_{P}] and a ternary sequence Tⱼ from a set of K N-chip preamble sequences T₁, T₂, . . . , T_{K}. The preamble symbol sequences T₁, T₂, . . . , T_{K} are code sequences which may be used similar to the sequence T for the preamble and are for example sequences from the sequences shown in the tables in FIGS. 3 and 4.

The sequence W is given by W=S [symbol] Tⱼ, i.e.

W=[s₁*Tⱼ, s₂*Tⱼ, . . . s_{P}*Tⱼ].

In this embodiment, to reduce memory usage in the transmitter 101 and the receiver 102, portions of the sequence S are generated using at least one of the N-chip preamble sequences T₁, T₂, . . . , T_{K}. For example, the sequence S includes B segments (sub-sequences) wherein the ith segment includes Pᵢ chips such that P=P₁+P₂+. . . +P_{B} with B≧1. For example, each segment is associated with a ternary sequence U, that is for example generated from one of the Tⱼ.

In one embodiment, the P-chip ternary base sequence S is constructed for the purpose of generating a P*N-chip long synchronization frame delimiter (SFD), W, from the set of K N-chip preambles, T₁, T₂, T₃, . . . , T_{K}, by carrying out, for each segment of the B segments of the sequence S:
assigning a N-chip sequence T to N chips of the segment (e.g. the first N chips of the segment) if the number Pⱼ of chips of the segment is greater or equal than N or assigning a Pⱼ-chip segment (sub-sequence) of the sequence T to the segment if Pⱼ is smaller than N wherein T is one of the preamble sequences T₁, T₂, T₃, . . . , T_{K}, one of the negative preamble sequences −T₁, −T₂, −T₃, . . . , −T_{K}, or a cyclic shifted version of one of the preamble sequences T₁, T₂, T₃, . . . , T_{K}, or one of the negative preamble sequences −T₁, −T₂, −T₃, . . . , −T_{K}; and if Pⱼ>N and j<B (i.e. not last segment) padding zeros for the remaining Pⱼ−N chips.

The negative preamble sequence −Tⱼ corresponding to a preamble sequence Tⱼ is the preamble sequence Tⱼ with all components being multiplied by −1.

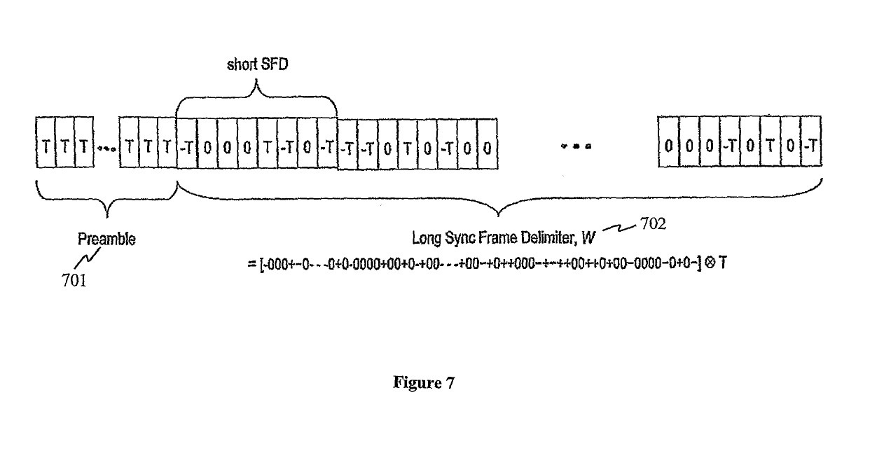

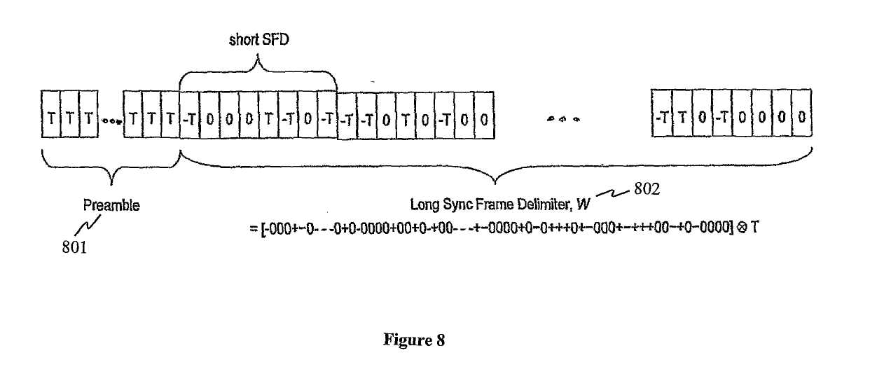

Examples for the for long synchronization frame delimiters generated as described above are illustrated in FIG. 7 and FIG. 8.

In the examples below, Tⱼ denotes the ternary sequence shown in jth row of the table 300 shown in FIG. 3.

FIG. 7 shows a preamble 701 and a long synchronization frame delimiter 702.

Similar to FIG. 5, the preamble 701 includes the repetition of the sequence T, which is in this example a N-chip ternary sequence where N=31.

P is 64 in this example and the long synchronization frame delimiter 701 is given as

W=S [symbol] Tⱼ
where S=[−T₅ (cyclic right shifted by 10 chips) 0 0 T₃]=[−(+000−+0+++0−0+0000−00−0+−00+++−) 00 −+0++000−+−++00++0+00−0000−0+0−]=[−000+−0−−−0+0−0000+00+0−+00−−−+00−+0++000−+−++00++0+00−0000−0+0−].

S has two segments, a first segment including P₁=33 chips being equal to −T₅ cyclic shifted to the right by 10 chips followed by two zero chips and a second segment including P₂=31 chips being equal to T3. Thus, S includes P=P₁+P₂=64 chips.

An another example, instead of using T3 at the end of S, also −T₃ may be used, such that
S=[−T₅ (cyclic right shifted by 10 chips) 0 0 −T₃]=[−(+000−+0+++0−0+0000−00−0+−00+++−) 00 −(−+0++000−+31 ++00++0+00−0000−0+0−)]=[−000+−0−−−0+0−0000+00+0−+00−−+−00+−0−−000+−+−−00−−0−00+0000+0−0+]. Otherwise this example is similar to the one shown in FIG. 7.

Another example is shown in FIG. 8.

FIG. 8 shows a preamble 801 and a long synchronization frame delimiter 802.

Similar to FIG. 5, the preamble 801 includes the repetition of the sequence T, which is in this example a N-chip ternary sequence where N=31.

P is 64 in this example and the long synchronization frame delimiter 801 is given as

W=S [symbol] Tⱼ
where S=[−T₅ (cyclic right shifted by 10 chips) T₁0 0]=[−(+000−+0+++0−0+0000−00−0+−00+++−)
−0000+0−0+++0+−000+−+++00−+0−00 00]=[−000+−0−−−0+0−0000+00+0−+00−−−+−0000+0−0+++0+−000+−+++00−+0−0000]

S has two segments, a first segment including P₁=31 chips being equal to −T₅ cyclic shifted to the right by 10 chips and a second segment including P₂=33 chips being equal to [T₁0 0]. Thus, S includes P=P₁+P₂=64 chips.

According to another example, S is given by S=[−T₅ (cyclic right shifted by 10 chips) 0 T₂0]=[−(+000−+0+++0−0+0000−00−0+−00+++−)
0+0+−0+0+000−++0−+−−−00+00++000 00]=[−000+−0−−−0+0−0000+00+0−+00−−−+0+0+−0+0+000−++0−+−−−00+00++00000].

S has two segments, a first segment including P₁=32 chips being equal to −T₅ cyclic shifted to the right by 10 chips and having a padded zero chip at the end and a second segment including P₂=32 chips being equal to T₂ and also having a padded zero chip at the end. Thus, S includes
P=P₁+P₂=64 chips.

In one embodiment, in case of a coherent receiver, the detector 105 may use the synchronization frame delimiter, i.e. the sequence W, itself as receive correlation sequence.

This means that the correlation sequence with which the transmission frame 200 is correlated by the detector 105 to detect the synchronization frame delimiter 202 in the transmission frame 200 is given as C_{coh}=S [symbol] T.

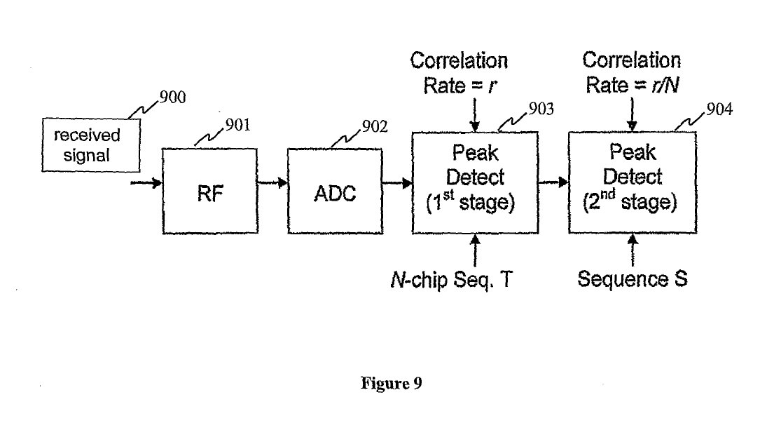

The reception of the transmission frame 200 and the detection of the synchronization frame delimiter 202 based on the correlation sequence C_{coh} is illustrated in FIG. 9.

FIG. 9 illustrates the processing of a received signal 900.

The processing illustrated in FIG. 9 is carried out by the receiver 102 shown in FIG. 1.

At first, the received signal 900, which is received via the receiver antenna 104 is processed by a radio frequency circuit 901. The radio frequency circuit 901 extracts an analogue data signal from the received signal 900, for example by demodulation of the received signal 900. The analogue data signal is then converted to a digital data signal by an analogue-to-digital converter 902.

The digital data signal holds the transmission frame 200. To determine the part of the data signal that holds the payload data packet 203, the synchronization frame delimiter 202 is detected.

In this example, this happens by two correlation stages which are part of the detector 105.

In a first correlation stage 903, the digital data signal is correlated with the N-chip sequence T used in the preamble 101. In a first correlation stage 904, the output of the first correlator stage is correlated with the sequence S. The second correlator stage is a low-rate correlator stage which has a correlation rate that is N times lower than the correlation rate of the first correlator stage.

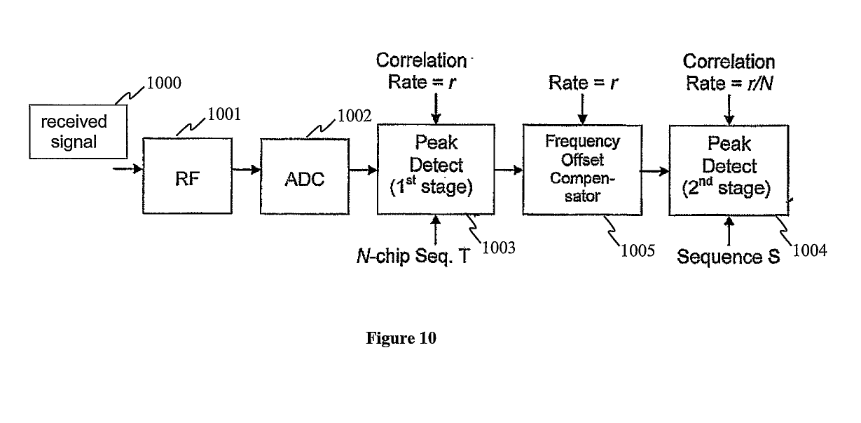

A common issue with coherent receivers is the frequency offset that may arise due to slightly different crystal clock frequency in the transmitter and receiver. Direct implication of this is that the phases of the correlation peaks out of the first stage 903 may drift and the performance of the second correlator stage 904 may be significantly degraded, especially when the sequence S is long. A possible counter measure is to insert a frequency offset compensator between the first correlator stage 903 and the second correlator stage 904 to correct the phase information of the output from first correlator stage 903. This is illustrated in FIG. 10.

FIG. 10 illustrates the processing of a received signal 1000.

As explained with reference to FIG. 9, the received signal 1000 is processed by a radio frequency stage 1001, an analogue to digital converter 1002, a first correlator stage 1003, and a second correlator stage 1004. In this example, the output of the first correlator stage 1003 is processed by a frequency offset compensator 1005 before it is fed to the second correlator stage 1004 to correct the phase information in the output of the first correlator stage 1003.

An alternative without the need for a frequency offset compensator 1005 is explained in the following.

According to one embodiment of the invention, instead of using C_{coh}=S [symbol] T as correlation sequence, C_{coh}=f(S) [symbol] T is used, e.g. by the detector 105, where the function f of a ternary sequence U is the transformation operation converting all non-zero chips in the sequence U to 1 and converting all zero chips in the sequence U to −1.

For example, if U=T₃, i.e.
T3=−+0++000−+−++00++0+00−0000−0+0−
f(U) is given as
f(T3)=++−++−−−+++++−−++−+−−+−−−−+−+−+.

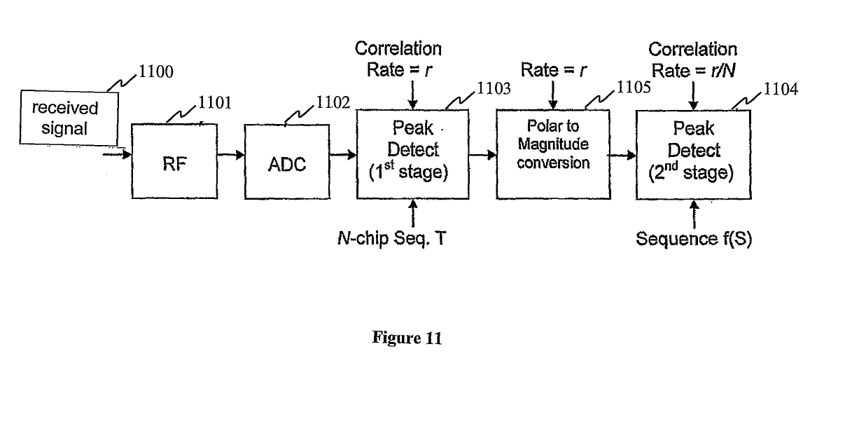

The usage of the sequence f(S) for detection of the synchronization frame delimiter is illustrated in FIG. 11. The processing illustrated in FIG. 11 is for example carried out by the detector 105 of the receiver 102. The correlation sequence C_{coh} is for example generated by a correlation sequence generator 108 of the receiver 102 that may also select the one or more of the symbol sequences Tⱼ from the memory 107 to generate the correlation sequence C_{coh}.

FIG. 11 illustrates the processing of a received signal 1100 according to an embodiment of the invention.

As explained with reference to FIG. 9, the received signal 1100 is processed by a radio frequency stage 1101, an analogue to digital converter 1102, a first correlator stage 1103, and a second correlator stage 1104. The first correlator stage 1103 carries out a correlation with the sequence T and the second correlator stage 1104 carries out a correlation with the sequence f(S). Before being fed to the second correlator stage 1104, the output of the first correlator stage 1103 is processed by a polar to magnitude conversion circuit 1105 which converts all −1 to 1 or, in other words, takes the absolute value of the output of the first correlator stage 1103.

As above, the second correlator stage 1104 is a low-rate correlator stage which has a correlation rate that is N times lower than the correlation rate of the first correlator stage 1103.

In case of the correlation sequence S used as long synchronization frame delimiter 602 in FIG. 6, i.e., S=[−000+−0−−−0+0−0000+00−+0−+00−−−
+00−+0++000−+−++00++0+00−0000−0+0−], the corresponding bipolar sequence f(S) for the correlation carried out by the second correlator stage 1104 is given by
f(S)=[+−−−++−+++−+−+−−−−+−−+−++−−++++−−++−++−−−+++++−−++−+−−+−−−−+−+−+].

1. A method for detecting a first symbol sequence in a data signal comprising
receiving the data signal in which the first symbol sequence should be detected, wherein the first symbol sequence is expressable as the kronecker product of a second symbol sequence and a third symbol sequence;
correlating the first symbol sequence with the third symbol sequence to generate a first correlation result;
generating a second correlation result by correlating a fourth symbol sequence derived from the first correlation result with a fifth symbol sequence derived from the second symbol sequence by a transformation that maps all negative symbols of the second symbol sequence to non-negative symbols; and
generating a detection result based on the second correlation result.

2. The method according to claim 1, the detection result being the information whether the first symbol sequence is present in the data signal.

3. The method according to claim 2, the detection result being the position of the first symbol sequence in the data signal.

4. The method according to claim 1, the fourth symbol sequence being derived from the first correlation result by taking the absolute value of the first correlation result.

5. The method according to claim 1, the first symbol sequence, the second code sequence and the third symbol sequence being three-valued sequences.

6. The method according to claim 1, the transformation mapping all non-zero symbols of the second symbol sequence to positive symbols and mapping the zero symbols of the second symbol sequence to negative symbols.

7. The method according to claim 1, the second symbol sequence being a ternary sequence and the fifth symbol sequence being the second symbol sequence transformed into a bipolar sequence.

8. The method according to claim 7, the second symbol sequence being transformed into a bipolar sequence by replacing each component having the value 0 with −1 and replacing each component having the value 1 or −1 with 1.

9. The method according to claim 1, the data signal further comprising a preamble symbol sequence comprising the third symbol sequence one or more times.

10. The method according to claim 1, the data signal further comprising a data payload symbol sequence and the first symbol sequence marking the end of the preamble symbol sequence and the beginning of the data payload symbol sequence.

11. The method according to claim 1, the first symbol sequence being a synchronization frame delimiter.

12. A system for detecting a first symbol sequence in a data signal comprising
a receiver receiving the data signal in which the first symbol sequence should be detected, wherein the first symbol sequence is expressable as the kronecker product of a second symbol sequence and a third symbol sequence;
a first correlator correlating the first symbol sequence with the third symbol sequence to generate a first correlation result;
a second correlator generating a second correlation result by correlating a fourth symbol sequence derived from the first correlation result with a fifth symbol sequence derived from the second symbol sequence by a transformation that maps all negative symbols of the second symbol sequence to non-negative symbols; and
a generating circuit generating a detection result based on the second correlation result.

13. A computer program product which, when executed by a computer, makes the computer perform a method for detecting a first symbol sequence in a data signal comprising
receiving the data signal in which the first symbol sequence should be detected, wherein the first symbol sequence is expressable as the kronecker product of a second symbol sequence and a third symbol sequence;
correlating the first symbol sequence with the third symbol sequence to generate a first correlation result;
generating a second correlation result by correlating a fourth symbol sequence derived from the first correlation result with a fifth symbol sequence derived from the second symbol sequence by a transformation that maps all negative symbols of the second symbol sequence to non-negative symbols; and
generating a detection result based on the second correlation result.

14. A method for generating a sub-sequence of a transmission symbol sequence, comprising
selecting a first symbol sequence from a plurality of preamble symbol sequences, the preamble symbol sequences pre-stored to be used in a preamble portion of the transmission symbol sequence;
generating a second symbol sequence, wherein the second symbol sequence being generated based on a fourth symbol sequence which is the first symbol sequence with the sign of each symbol being inverted, a cyclically shifted version of the first symbol sequence or a cyclically shifted version of the first symbol sequence with the sign of each symbol being inverted; and
combining the second symbol sequence with a third symbol sequence selected from the plurality of preamble symbol sequences to generate the sub-sequence.

15. The method according to claim 14, the sub-sequence being generated as the kronecker product of the second symbol sequence and the third symbol sequence.

16. (canceled)

17. The method according to claim 14, the second symbol sequence being generated based on the fourth symbol sequence and a fifth symbol sequence which is a sixth symbol sequence selected from the plurality of preamble symbol sequences, the sixth symbol sequence with the sign of each symbol being inverted, a cyclically shifted version of the sixth symbol sequence or a cyclically shifted version of the sixth symbol sequence with the sign of each symbol being inverted.

18. The method according to claim 14, the transmission symbol sequence comprising a data payload symbol sequence and the sub-sequence marking the end of the preamble portion and the beginning of the data payload symbol sequence.

19. The method according to claim 17, the sub-sequence being a synchronization frame delimiter.

20. The method according to claim 14, the sub-sequence being a bipolar sequence or a ternary sequence.

21. The method according to claim 14, the first symbol sequence, the second symbol sequence, and the third symbol sequence being two-valued sequences or three-valued sequences.

22. A system for generating a sub-sequence of a transmission symbol sequence, comprising
a selecting circuit selecting a first symbol sequence from a plurality of preamble symbol sequences, the preamble symbol sequences pre-stored to be used in a preamble portion of the transmission symbol sequence;
a generating circuit generating a second symbol sequence, wherein the second symbol sequence being generated based on a fourth symbol sequence which is the first symbol sequence with the sign of each symbol being inverted, a cyclically shifted version of the first symbol sequence or a cyclically shifted version of the first symbol sequence with the sign of each symbol being inverted; and
a combining circuit combining the second symbol sequence with a third symbol sequence selected from the plurality of preamble symbol sequences to generate the sub-sequence.

23. A computer program product which, when executed by a computer, makes the computer perform a method for generating a sub-sequence of a transmission symbol sequence, comprising
selecting a first symbol sequence from a plurality of preamble symbol sequences, the preamble symbol sequences pre-stored to be used in a preamble portion of the transmission symbol sequence;
generating a second symbol sequence, wherein the second symbol sequence being generated based on a fourth symbol sequence which is the first symbol sequence with the sign of each symbol being inverted, a cyclically shifted version of the first symbol sequence or a cyclically shifted version of the first symbol sequence with the sign of each symbol being inverted; and
combining the second symbol sequence with a third symbol sequence selected from the plurality of preamble symbol sequences to generate the sub-sequence.
